(19) United States
(12) Patent Application Publication
(10) Pub. No.: US 2009/0277939 A1
(43) Pub. Date: Nov. 12, 2009

(54) NAIL GUN HANGING DEVICE

(75) Inventor: Chen-Ho Ou, Taichung Hsien (TW)

Correspondence Address: CONNOLLY BOVE LODGE & HUTZ LLP, 1875 EYE STREET, N.W., SUITE 1100, WASHINGTON, DC, 20006, US

(73) Assignee: PANREX INDUSTRIAL CO., LTD., Tai-Ping City (TW)

(21) Appl. No.: 12/117,326

(22) Filed: May 8, 2008

(51) Int. Cl. A45F 5/00; F16M 11/00

(52) U.S. Cl. 224/269; 248/682

(57) ABSTRACT

A nail gun hanging device includes: a coupling member having a first axial end portion adapted to be secured to a handle of a nail gun, and an opposite second axial end portion; a hanger having a sleeve portion and a hook portion protruding from the sleeve portion, the sleeve portion being sleeved rotatably and co-axially on the second axial end portion; and a resilient plate disposed between and abutting resiliently against the second axial end portion and the sleeve portion of the hanger, and having a deformable protrusion protruding therefrom to abut resiliently against one of the second axial end portion and the sleeve portion of the hanger.

### BACKGROUND OF THE INVENTION

1. Field of the Invention

The invention relates to a nail gun hanging device, more particularly to a nail gun hanging device including a coupling member and a hanger rotatable relative to the coupling member.

2. Description of the Related Art

Most nail guns are equipped with hanging devices connected to handles thereof so as to allow workmen to hang the nail guns around their waists. The hanging device has a part rotatable relative to the handle of the nail gun so as to permit disposition of the nail gun at a desired position or side (left or right side) of the waist of the workmen that facilitates access.

Referring to FIGS. 1 and 2, a conventional nail gun hanging device 7 is shown to be adapted to be connected to a handle 61 of a nail gun 6, and includes a cylindrical coupling member 71 adapted to be secured to the handle 61, a hanger 72 sleeved on the coupling member 71 and formed with a threaded hole 721, and a positioning unit 73 extending through the threaded hole 721 for positioning the hanger 72 at a desired angular position relative to the coupling member 71. The coupling member 71 includes a ring wall 711 formed with a plurality of positioning grooves 712. The positioning unit 73 includes a positioning stud 731 operable to engage a selected one of the positioning grooves 712, a spring 732 for urging the positioning stud 731 to engage the selected one of the positioning grooves 712, and a fastener 733 abutting against the spring 732.

When the nail gun 6 is to be positioned at a desired position relative to the waist of the workmen, the hanger 72 is operated to rotate relative to the coupling member 71 such that the positioning stud 731 is disengaged from the current one of the positioning grooves 712, and is subsequently moved to and engages a new selected one of the positioning grooves 712. However, there is a need to reduce the number of the components of the positioning unit 73 of the conventional nail gun hanging device 7 so as to reduce the assembly time and manufacturing costs.

### SUMMARY OF THE INVENTION

Therefore, an object of the present invention is to provide a nail gun hanging device that can overcome the aforesaid drawback associated with the prior art.

Accordingly, a nail gun hanging device of the present invention is adapted to be connected to a handle of a nail gun, and comprises: a cylindrical coupling member defining a central axis and having a first axial end portion adapted to be secured to the handle of the nail gun, and a second axial end portion opposite to the first axial end portion along the central axis; a hanger having a sleeve portion and a hook portion protruding from the sleeve portion and adapted to be used to hook on an object, the sleeve portion being sleeved rotatably and co-axially on the second axial end portion of the coupling member; and a single piece of a resilient plate disposed between and abutting resiliently against the second axial end portion of the coupling member and the sleeve portion of the hanger, and having a deformable protrusion protruding therefrom to abut resiliently against one of the second axial end portion of the coupling member and the sleeve portion of the hanger. Said one of the second axial end portion of the coupling member and the sleeve portion of the hanger is formed with a plurality of retaining grooves. The deformable protrusion of the resilient plate extends into a selected one of the retaining grooves.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional nail gun hanging device;

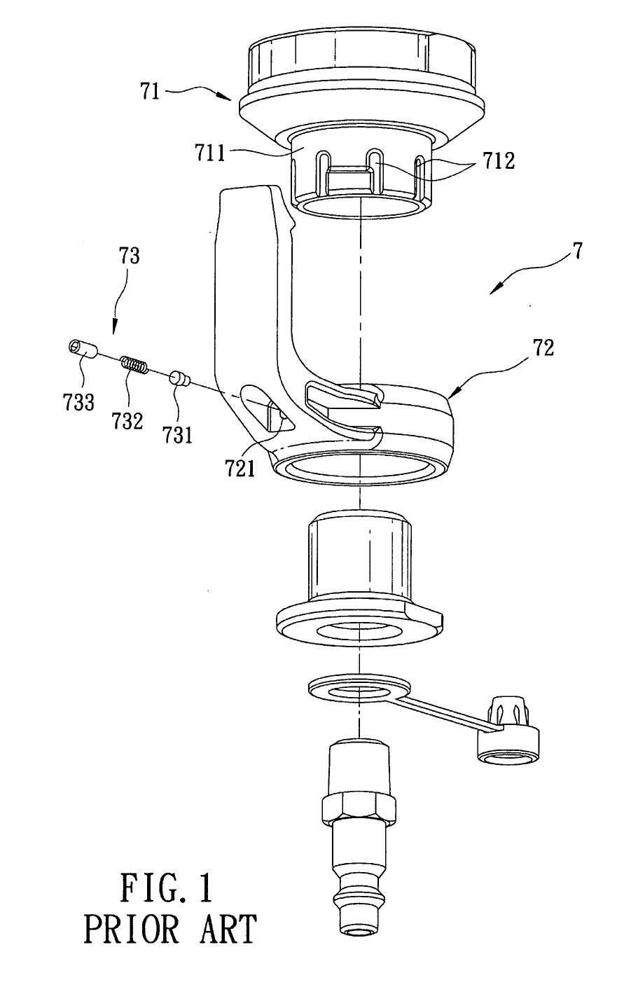

FIG. 2 is a fragmentary sectional view to illustrate a positioning unit of the conventional nail gun hanging device;

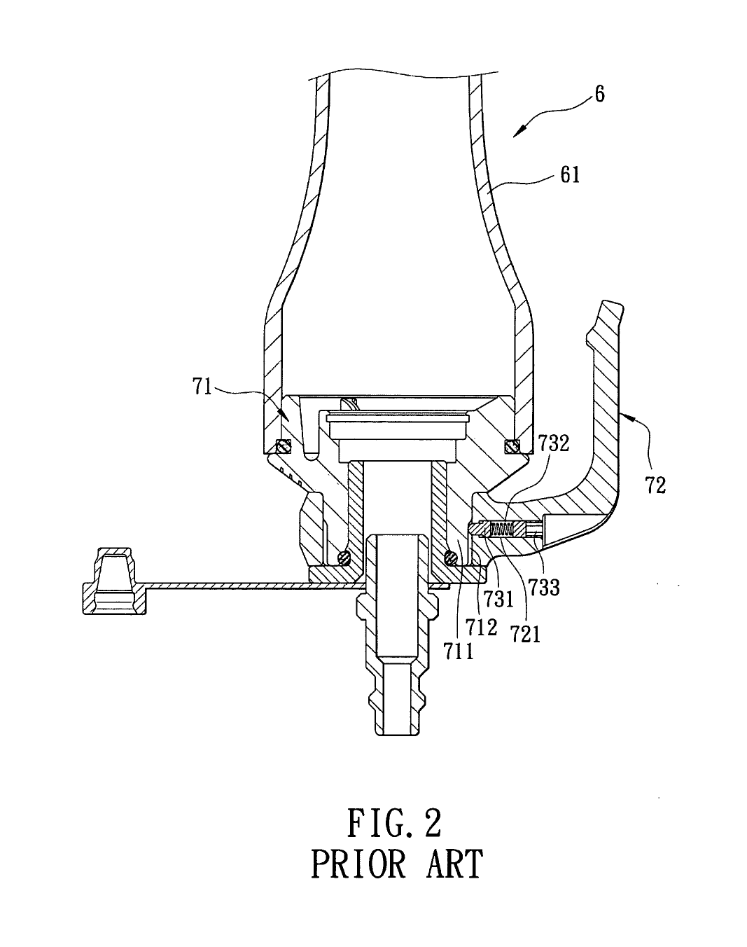

FIG. 3 is an exploded perspective view of the preferred embodiment of a nail gun hanging device according to the present invention for connecting to a handle of a nail gun;

FIG. 4 is a fragmentary sectional view of the preferred embodiment for illustrating how a coupling member engages a hanger thereof; and

FIG. 5 is a sectional view taken along the line V-V in FIG. 4.

### DETAILED DESCRIPTION OF THE PREFERRED EMBODIMENT

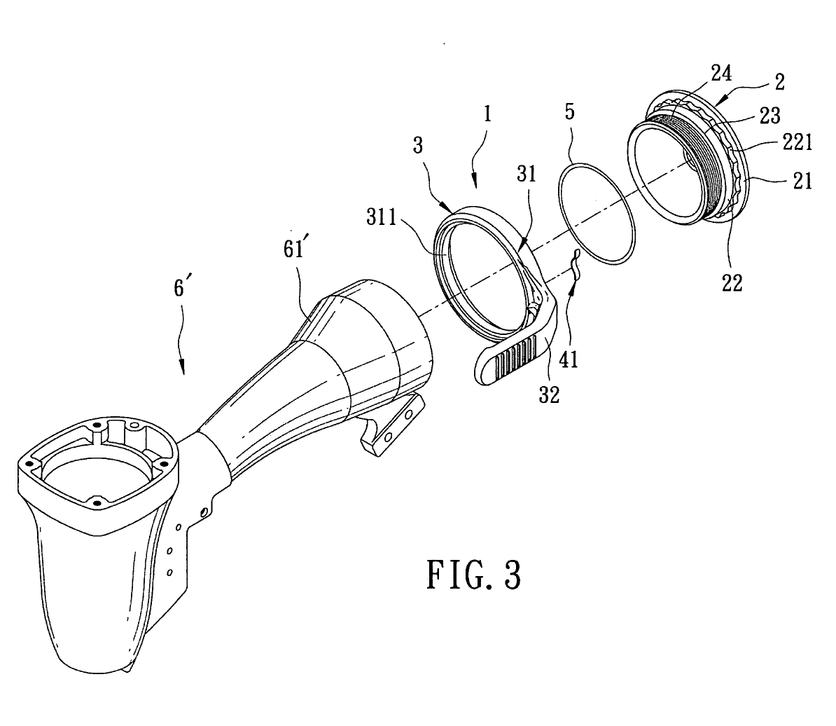

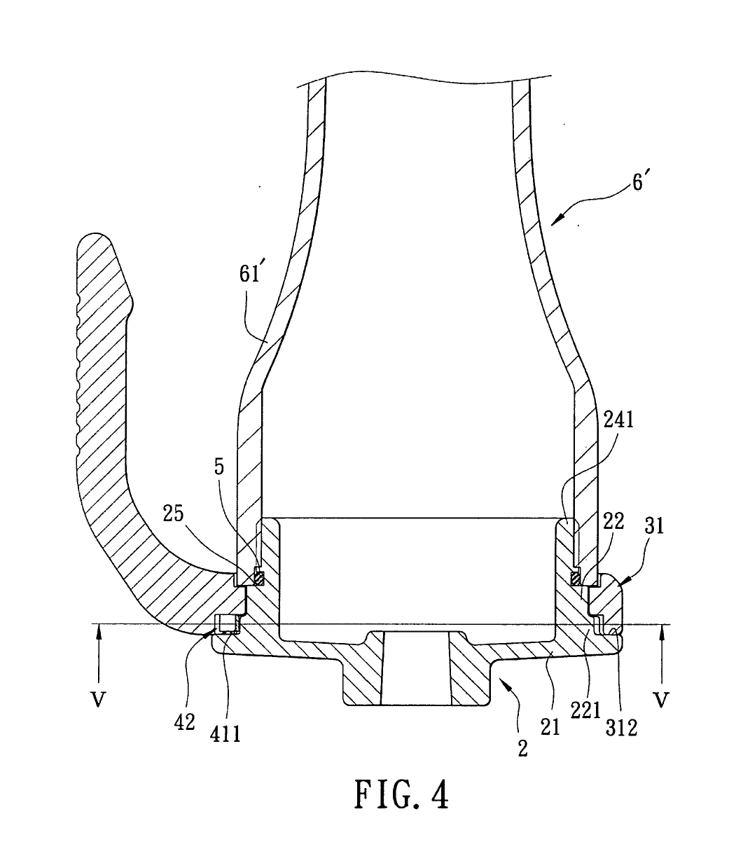

Referring to FIGS. 3 to 5, the preferred embodiment of a nail gun hanging device 1 according to the present invention is shown to be adapted to be connected to a handle 61′ of a nail gun 6′. The nail gun hanging device 1 includes: a cylindrical coupling member 2 defining a central axis and having a first axial end portion 24 adapted to be secured to the handle 61′ of the nail gun 6′, and a second axial end portion 22 opposite to the first axial end portion 24 along the central axis; a hanger 3 having a sleeve portion 31 and a hook portion 32 protruding from the sleeve portion 31 and adapted to be used to hook on an object, such as a belt (not shown), the sleeve portion 31 being sleeved rotatably and co-axially on the second axial end portion 22 of the coupling member 2; and a single piece of a resilient plate 41 disposed between and abutting resiliently against the second axial end portion 22 of the coupling member 2 and the sleeve portion 31 of the hanger 3, and having a deformable protrusion 411 protruding therefrom to abut resiliently against one of the second axial end portion 22 of the coupling member 2 and the sleeve portion 31 of the hanger 3. Said one of the second axial end portion 22 of the coupling member 2 and the sleeve portion 31 of the hanger 3 is formed with a plurality of retaining grooves 43. In this preferred embodiment, the retaining grooves 43 are formed in the second axial end portion 22 of the coupling member 2. The deformable protrusion 411 of the resilient plate 41 extends into a selected one of the retaining grooves 43.

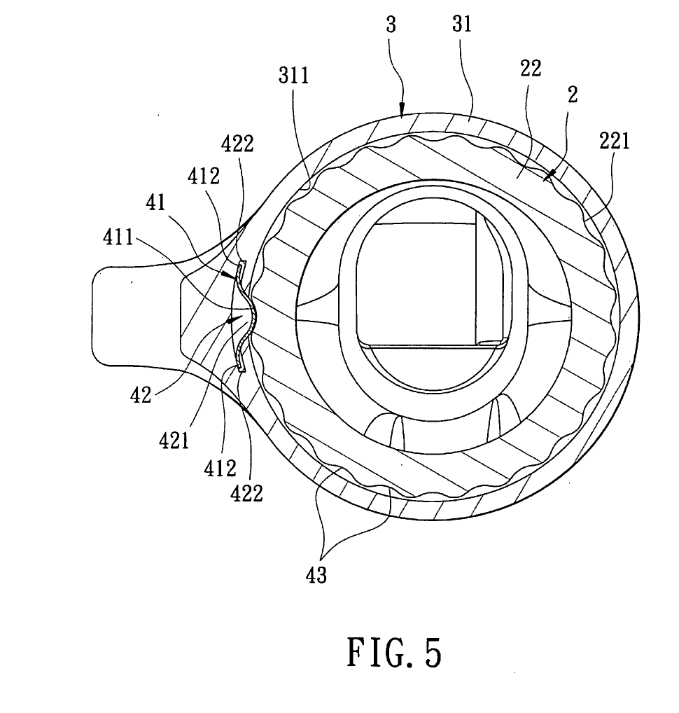

In this embodiment, the deformable protrusion 411 of the resilient plate 41 has a round shape, and abuts resiliently against the sleeve portion 31 of the hanger 3. The resilient plate 41 further has two opposite end portions 412 extending in opposite directions from the deformable protrusion 411. The other of the second axial end portion 22 of the coupling member 2 and the sleeve portion 31 of the hanger 3 is formed with a retaining recess 42 such that the resilient plate 41 is retained in the retaining recess 42. In this embodiment, the retaining recess 42 is formed in and is indented inwardly from an inner surface 311 of the sleeve portion 31 of the hanger 3, and has a T-shape. The end portions 412 of the resilient plate 41 extend respectively into two end segments 422 of the retaining recess 42, and the deformable protrusion 411 of the resilient plate 41 protrudes outwardly from a middle segment 421 of the retaining recess 42, as best shown in FIG. 5.

The coupling member 2 further has an abutting flange 21. The second axial end portion 22 of the coupling member 2 has a toothed segment 221 extending axially and reduced in cross-section from the abutting flange 21 and formed with the retaining grooves 42 that are equiangularly displaced. The sleeve portion 31 of the hanger 3 has an axial end 312 abutting against the abutting flange 21 of the coupling member 2. The first axial end portion 24 of the coupling member 2 has a threaded segment 241 extending axially from the second axial end portion 22 to engage threadedly the handle 61′.

The second axial end portion 22 of the coupling member 2 is further formed with an annular groove 25. The nail gun hanging device 1 further includes a ring pad 5 received in the annular groove 25 and in sealing contact with the handle 61′ and the second axial end portion 22 of the coupling member 2.

In operation, when the nail gun 6′ is to be positioned at a desired position, the sleeve portion 31 of the hanger 3 is rotated about the central axis relative to the coupling member 2 such that the protrusion 411 of the resilient plate 41 is deformed to disengage from a current one of the retaining grooves 43 and is subsequently moved to and engages a new selected one of the retaining grooves 43.

With the inclusion of the resilient plate 41 in the nail gun hanging device 1 of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A nail gun hanging device adapted to be connected to a handle of a nail gun, said nail gun hanging device comprising:
a cylindrical coupling member defining a central axis and having a first axial end portion adapted to be secured to the handle of the nail gun, and a second axial end portion opposite to said first axial end portion along said central axis;
a hanger having a sleeve portion and a hook portion protruding from said sleeve portion and adapted to be used to hook on an object, said sleeve portion being sleeved rotatably and co-axially on said second axial end portion of said coupling member; and
a single piece of a resilient plate disposed between and abutting resiliently against said second axial end portion of said coupling member and said sleeve portion of said hanger, and having a deformable protrusion protruding therefrom to abut resiliently against one of said second axial end portion of said coupling member and said sleeve portion of said hanger;
wherein said one of said second axial end portion of said coupling member and said sleeve portion of said hanger is formed with a plurality of retaining grooves; and
wherein said deformable protrusion of said resilient plate extends into a selected one of said retaining grooves.

2. The nail gun hanging device of claim 1, wherein said resilient plate further has two opposite end portions extending in opposite directions from said deformable protrusion, said protrusion being round in shape.

3. The nail gun hanging device of claim 1, wherein the other of said second axial end portion of said coupling member and said sleeve portion of said hanger is formed with a retaining recess, said resilient plate being retained in said retaining recess, said deformable protrusion protruding outwardly of said retaining recess.

4. The nail gun hanging device of claim 3, wherein said retaining recess is T-shaped.

5. The nail gun hanging device of claim 1, wherein said coupling member further has an abutting flange, said second axial end portion of said coupling member having a toothed segment extending axially and reduced in cross-section from said abutting flange and formed with said retaining grooves that are equiangularly displaced, said sleeve portion of said hanger having an axial end abutting against said abutting flange of said coupling member.

6. The nail gun hanging device of claim 1, wherein said first axial end portion of said coupling member has a threaded segment extending axially from said second axial end portion and adapted to engage threadedly the handle of the nail gun.
